(19) United States
(12) Patent Application Publication
(10) Pub. No.: US 2018/0129100 A1
(43) Pub. Date: May 10, 2018

(54) LIGHT GUIDING STRUCTURE, DISPLAY DEVICE HAVING THE SAME AND MANUFACTURING METHOD THEREOF

(71) Applicants: EFUN Technology Co., LTD., Tainan City (TW); SIC Technology Co., LTD., Hsinchu City (TW)

(72) Inventors: Ying-Tsung LU, Tainan City (TW); Shien-Tsung Wu, Hsinchu City (TW); Yi-Lin Tang, Tainan City (TW)

(21) Appl. No.: 15/647,810

(22) Filed: Jul. 12, 2017

(30) Foreign Application Priority Data
Nov. 7, 2016 (TW) 105136114

(51) Int. Cl. G02F 1/1335

(52) U.S. Cl. CPC G02F 1/133524; G02F 1/133553

(57) ABSTRACT

The present invention provides a light guiding structure, a display device having the same and a manufacturing method therefor. The light guiding structure includes: a light guiding layer; and a reflecting layer including a reflecting material and a substrate having a first surface and a second surface, wherein the first surface of the substrate has at least one micro-structure, and the reflecting material at least partially covers the first surface of the substrate to form the reflecting layer. The manufacturing method includes: providing a substrate having a first surface and forming at least one micro-structure on the first surface of the substrate by a roll embossing process to form a reflecting layer; providing a light guiding layer having a bottom surface; and providing a bonding layer configured to bond the bottom surface of the light guiding layer and the first surface of the reflecting layer together.

### RELATED APPLICATIONS

This application claims the priority of Taiwan Patent Application No. 105136114, filed on Nov. 7, 2016, at the Taiwan Intellectual Property Office, the entire disclosure of which is incorporated herein by reference.

### FIELD OF THE INVENTION

The present invention relates to a light guiding structure, a display device having the same and the manufacturing method thereof, specifically a light guiding structure having a light guiding layer without any micro-structure in the light guiding layer and the manufacturing method thereof.

### BACKGROUND OF THE INVENTION

Nowadays, the light guiding plate used in the light source module of the liquid crystal display is a light guiding glass plate basically, because the hardness of glass is better than that of conventional acrylic. It needs a thickness of 3 mm to 5 mm for a light guiding acrylic plate but only of 1 mm to 2 mm for a light guiding glass plate, and therefore using the light guiding glass plate can make the liquid crystal display become thinner.

Please refer to FIG. 1, which is a schematic diagram of the prior liquid crystal display. The prior liquid crystal display 100 includes a liquid crystal panel 110, a light source 120, a light guiding glass plate 130, an optical clear adhesive 140 and a reflective plate 150, wherein the light guiding glass plate 130 further includes a light entrance surface 131, a light-emitting surface 132, a bottom surface 133 and a plurality of mesh points 134. The plurality of mesh points 134 of the light guiding glass plate 130 are formed on the bottom surface 133 and destroys total reflection of light through applying the patterns of the plurality of mesh points 134, so that the incident light through the light entrance surface 131 can be emitted from the light-emitting surface 132 to generate a planar light source for the prior liquid crystal display 100.

Please refer to FIG. 2, which shows the flow of the prior manufacturing method of a liquid crystal display. The prior manufacturing method 200 includes the following steps: providing a glass substrate (S201); designing patterns of screen printing (S202); forming a plurality of mesh points on the bottom surface of the glass substrate to form a light guiding glass plate by the screen printing technique and according to the designed patterns (S203); providing a reflective plate (S204); providing an optical clear adhesive to bond the bottom surface of the light guiding glass plate and the top surface of the reflective plate together (S205); providing a light source configured outside the light entrance surface of the light guiding glass plate (S206); and providing a liquid crystal panel configured on the light guiding glass plate to form the liquid crystal display (S207).

However, the screen printing technique applied in the process of manufacturing the light guiding glass plate needs not only the ink printing step but also the baking step, etc., and each of the glass substrates is separately or individually processed using the screen printing technique, so that it is more time consuming. Moreover, since it is more difficult to perform the ink printing step on the glass substrate, the cost for applying the screen printing technique to the glass substrate is more expensive. Therefore, once the above-mentioned problems are solved, the speed of manufacturing a liquid crystal display can be increased and the manufacturing cost can be reduced.

In order to circumvent all the above issues, the inventors have proposed an invention “LIGHT GUIDING STRUCTURE, DISPLAY DEVICE HAVING THE SAME AND MANUFACTURING METHOD THEREOF.” Using the structure, the device and the manufacturing method of the present invention, it can increase the speed of manufacturing a liquid crystal display and reduce the manufacturing cost. The summary of the present invention is described as follows.

### SUMMARY OF THE INVENTION

According to a first aspect of the present invention, a light guiding structure is provided and includes a light guiding layer and a reflecting layer. The light guiding layer includes a first surface and a second surface, and the reflecting layer includes a reflecting material and a substrate having a first surface and a second surface. The first surface of the substrate has at least one micro-structure, the reflecting material at least partially covers the first surface of the substrate to form the reflecting layer, and the first surface of the substrate is configured opposite the second surface of the light guiding layer.

Preferably, the light guiding structure further comprises a bonding layer configured between the second surface of the light guiding layer and the first surface of the substrate, so as to bond the light guiding layer and the reflecting layer together, wherein the guiding layer is free from a structure that can destroy total reflection.

Preferably, the bonding layer includes an optical clear adhesive.

Preferably, the bonding layer has a thickness, and the thickness ranges from 10 μm to 1000 μm.

Preferably, the at least one micro-structure includes a pattern, a Lambertian surface, a V-cut structure or a microlens.

Preferably, the reflecting layer has a thickness, and the thickness ranges from 1 μm to 1000 μm.

Preferably, the light guiding layer is a light guiding glass layer or a light guiding acrylic layer.

Preferably, the reflecting material is an aluminum (Al), a silver (Ag), a gold (Au), a copper (Cu) or the combination thereof.

Preferably, the reflecting layer is formed at least by a roll embossing process.

According to the second aspect of the present invention, a liquid crystal display is provided. The liquid crystal display includes a light guiding layer, a reflecting layer and a bonding layer. The reflecting layer includes a substrate having at least one micro-structure, and the bonding layer is configured between the light guiding layer and the reflecting layer to bond the light guiding layer and the reflecting layer together.

Preferably, the reflecting layer further includes a reflecting material, and the reflecting material at least partially covers the substrate to form the reflecting layer.

According to another aspect of the present invention, a manufacturing method of a light guiding structure is provided. The manufacturing method includes providing a substrate having a first surface and forming at least one micro-structure on the first surface of the substrate by a roll embossing process to form a reflecting layer; providing a light guiding layer having a bottom surface; and providing a bonding layer configured to bond the bottom surface of the light guiding layer and the first surface of the reflecting layer together.

Preferably, the step of forming the reflecting layer further includes providing a reflecting material to at least partially cover the first surface of the substrate.

The light guiding layer of the present invention does not need to be processed with the screen printing technique or other special methods to form any micro-structure that can destroy total reflection thereon, and the micro-structure that can destroy total reflection is formed on the reflecting layer through a roll embossing process. Accordingly, applying the light guiding structure, the display device with the light guiding structure and the manufacturing method of the present invention can increase the speed of manufacturing a liquid crystal display and reduce the manufacturing cost.

The present invention will be more clearly understood through the following descriptions with reference to the drawings:

### BRIEF DESCRIPTION OF THE DRAWINGS

FIG. 1 is a schematic diagram showing the prior liquid crystal display.

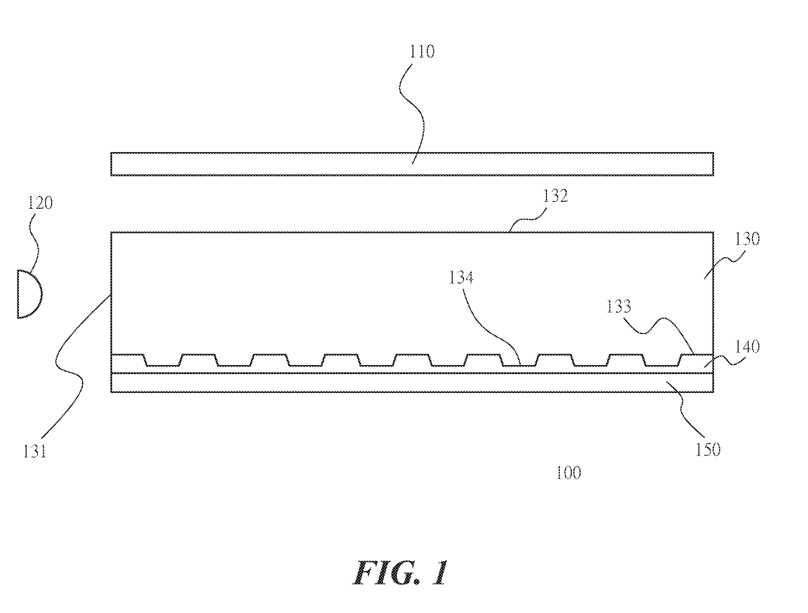

FIG. 2 is a schematic diagram showing the flow of the prior manufacturing method of a liquid crystal display.

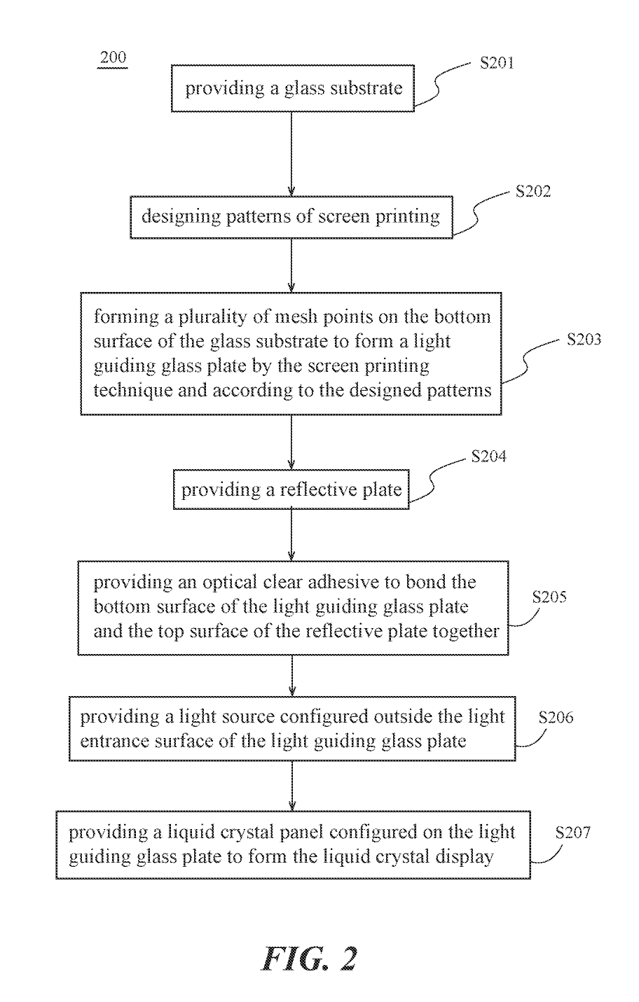

FIG. 3 is a schematic diagram showing the first embodiment according to the present invention.

FIG. 4 is a schematic diagram showing the second embodiment according to the present invention.

FIG. 5 is a schematic diagram showing the flow of the manufacturing method of a light guiding structure according to the present invention.

### DETAILED DESCRIPTION OF THE PREFERRED EMBODIMENTS

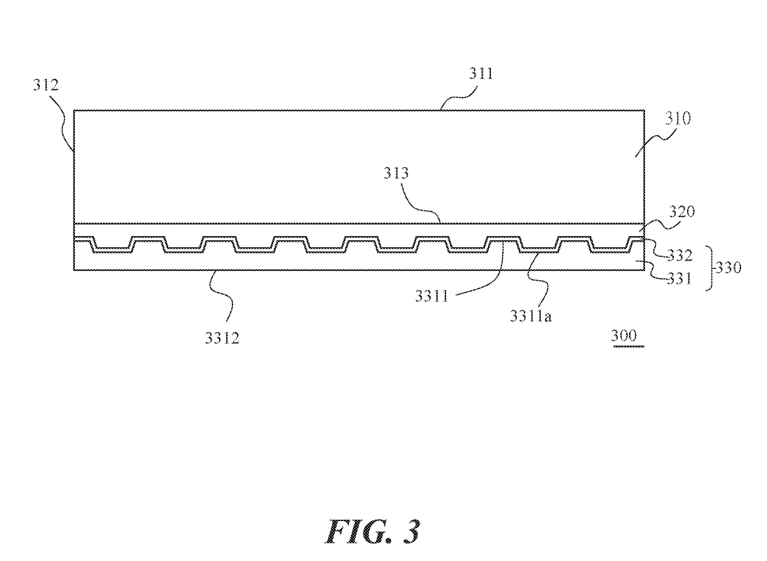

Please refer to FIG. 3, which is a schematic diagram showing the first embodiment according to the present invention. The light guiding structure 300 includes a light guiding glass layer 310, a bonding layer 320 and a reflecting layer 330, wherein the light guiding glass layer 310 has a light-emitting surface 311, a light entrance surface 312 and a bottom surface 313, and the reflecting layer 330 has a substrate 331 and a reflecting material 332. The substrate 331 further includes a top surface 3311 and a bottom surface 3312, and the top surface 3311 has a plurality of micro-structures 3311a. Moreover, the reflecting material 332 is configured to at least partially or totally cover the top surface 3311 of the substrate 331. The light guiding glass layer 310 is configured on the reflecting layer 330, and the bottom surface 313 of the light guiding glass layer 310 is opposite to the top surface 3311 of the substrate 331 of the reflecting layer 330. The bonding layer 320 is configured between the bottom surface 313 of the light guiding glass layer 310 and the top surface 3311 of the substrate 331 of the reflecting layer 330, so as to bond the light guiding glass layer 310 and the reflecting layer 330 together.

The substrate 331 of the reflecting layer 330 is made or formed through a roll embossing process, the shape and the position of the plurality of micro-structures 3311a of the top surface 3311 are determined by the mold of the roll embossing process, and the material of the substrate 331 can be a flexible material, such as polyethylene terephthalate (PET), cyclo olefin (co)-polymers (COC), polyimide (PI), polyestersulfone (PES), polyethylene naphthalate (PEN), polycarbonate (PC), polyethylene (PE), etc. or a combination thereof. The plurality of micro-structures includes at least a pattern, a Lambertian surface, a V-cut structure, a microlens or a combination thereof, wherein the pattern can be a circle, a rhombus, a triangle and so on, the range of the depth to width ratio of the Lambertian surface can be 1:2 to 1:10, and the microlens can be a spherical lens, an aspheric lens or a combination thereof. The reflecting material 332 can be an aluminum (Al), a silver (Ag), a gold (Au), a copper (Cu), other metals, any material with reflection property or a combination thereof. The reflecting material 332 can be formed on the top surface 3311 of the substrate 331 through a vapor deposition process or other coating process, and at least partially covers or totally covers the top surface 3311 of the substrate 331 to form the reflecting layer 330, wherein the vapor deposition process can be an evaporation method, a sputtering method, a physical vapor deposition method or a chemical vapor deposition method. The reflecting material 332 forms the reflecting surface of the reflecting layer 330 according to the shape of the top surface 3311 of the substrate 331. In other words, the reflecting surface of the reflecting layer 330 has the shape corresponding to that of the plurality of micro-structures 3311a. For example, if the micro-structure 3311a is a spherical lens, the spherical lens covered with the reflecting material 332 will cause the reflecting surface of the reflecting layer 330 to have a spherical mirror. In addition, the range of the thickness of the reflecting layer 330 of this embodiment can be 1˜1500 nm, and preferably, the thickness is 10˜100 nm. If the material of the substrate 331 has reflection property, the substrate 331 can directly form the reflecting layer 330 only via the roll embossing process. Furthermore, when the light guiding structure 300 is applied to a display device, the substrate 331 of the reflecting layer 330 can directly function as the case of the display device and the bottom surface 3312 is the bottom or rear surface of the case.

The bonding material is used for or is used as the bonding layer 320 to bond the light guiding layer 310 and the reflecting layer 330 together, and the bonding material preferably is a material having optical clear adhesive (OCA) or the same-level material. The thickness range of the bonding layer 320 of this embodiment can be 1˜1000 μm, and the preferable thickness range is 10˜50 μm.

The light-emitting surface 311 of the light guiding glass layer 310 is used to cause a part of the light in the light guiding glass layer 310 to be emitted from the light-emitting surface 311. The light entrance surface 312 of the light guiding glass layer 310 can be a plane/flat surface and perpendicular to the light-emitting surface 311, and is used for receiving the light emitted by a light source outside the light guiding glass layer 310. After the light enters into the light guiding glass layer 310 via the entrance surface 312, a part of the light will always reflect inside the light guiding glass layer 310 because of total internal reflection principle. However, when the light is transmitted to the reflecting surface of the reflecting layer 330, the light will be guided to the light-emitting surface 311 because the micro-structures on the reflecting surface corresponding the plurality of micro-structures 3311a destroy the total reflection of the light. Then the light will be emitted from the light guiding glass layer 310 to achieve the goal of providing a planar light source for a display panel. In other words, the micro-structures capable of destroying the total reflection of the light guiding glass layer 310 are formed on the reflecting layer 330 rather than formed on the light guiding glass layer 310. In addition, the thickness range of the light guiding glass layer 310 of this embodiment can be 300˜5000 μm according to the demand. Furthermore, the light guiding layer of the light guiding structure 300 can be a light guiding acrylic layer or can be made of other materials.

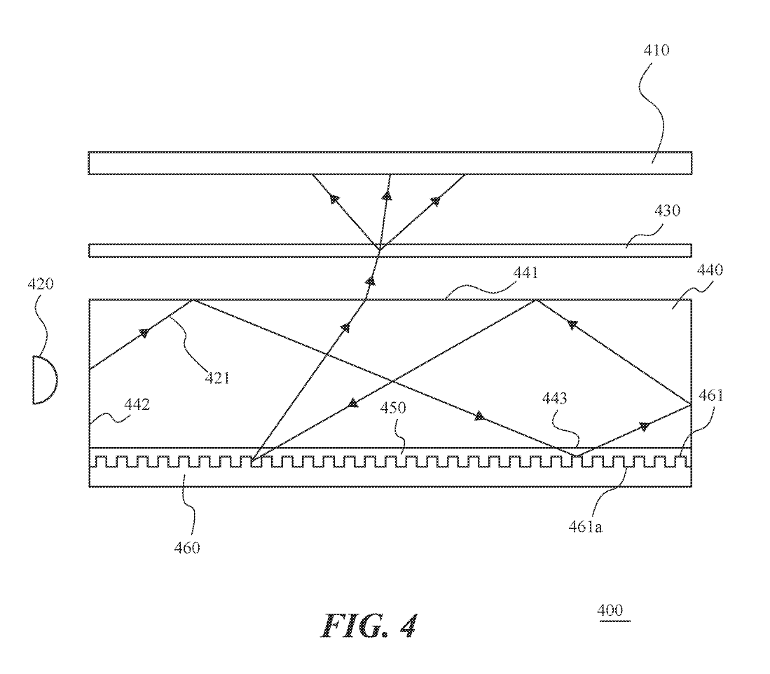

Please refer to FIG. 4, which is a schematic diagram showing the second embodiment according to the present invention. The liquid crystal display 400 includes a liquid crystal panel 410, a light source 420, a diffusion layer 430, a light guiding layer 440, a bonding layer 450 and a reflecting layer 460, wherein the light guiding layer 440 has a light-emitting surface 441, a light entrance surface 442 and a bottom surface 443, the reflecting layer 460 has a reflecting surface 461, and the reflecting surface 461 has a plurality of micro-structures 461a. The light source 420 is configured near the light entrance surface 442 of the light guiding layer 440 to provide light 421. The diffusion layer 430 is configured between the liquid crystal panel 410 and the light guiding layer 440. The light guiding layer 440 is configured on the reflecting layer 460, and the bottom surface 443 of the light guiding layer 440 is opposite to the reflecting surface 461 of the reflecting layer 460. The bonding layer 450 is configured between the bottom surface 443 of the light guiding layer 440 and the reflecting surface 461 of the reflecting layer 460, so as to bond the light guiding layer 440 and the reflecting layer 460 together.

The plurality of micro-structures 461a of the reflecting surface 461 of the reflecting layer 460 are formed through a roll embossing process. The design of the mold of the roll embossing process determines the shape and the position of the plurality of micro-structures 461a, and the plurality of micro-structures 461 can be patterns, Lambertian surfaces, V-cut structures, microlenses or other structures capable of destroying the total reflection in the light guiding layer 440. The reflecting surface 461 can be formed by deposition or coating with reflecting material. Moreover, additional reflecting material can be formed on the reflecting surface 461 of reflection property via a vapor deposition step or other coating step to enhance the reflection effect. The bonding layer 450 uses optical clear adhesive (OCA) or the same-level bonding material to bond the light guiding layer 440 and the reflecting layer 460 together, so as to make the light 421 be successfully transmitted to the reflecting layer 460. The diffusion layer 430 is configured to make the incident light refracted, reflected and scattered to cause optical diffusion effect, so as to provide a uniform planar light source for liquid crystal panel 410.

The light entrance surface 442 of the light guiding layer 440 is a plane and perpendicular to the light-emitting surface 441. After the light 421 emitted from the light source 420 enters into the light guiding layer 440 through the entrance surface 442, the light 421 will reflect in the light guiding layer 440 because of total internal reflection principle. When the light 421 is reflected to the bottom surface 443, the light 421 will be reflected again to the reflecting surface 461 of the reflecting layer 460 and then go back to the light guiding layer 440 via reflection and refraction. If the light 421 is transmitted to the micro-structure 461a of the reflecting surface 461, the light 421 will be guided to the light-emitting surface 441 and then be emitted from the light guiding layer 440 because the micro-structure 461a on the reflecting surface 461 destroys the total reflection of light in the light guiding layer 440. After the light 421 is emitted out of the light-emitting surface 441, the light 421 will be transmitted to the diffusion layer 430. In the diffusion layer 430, the light 421 will be reflected, refracted and/or scattered many times, and finally be transmitted to the liquid crystal panel 410.

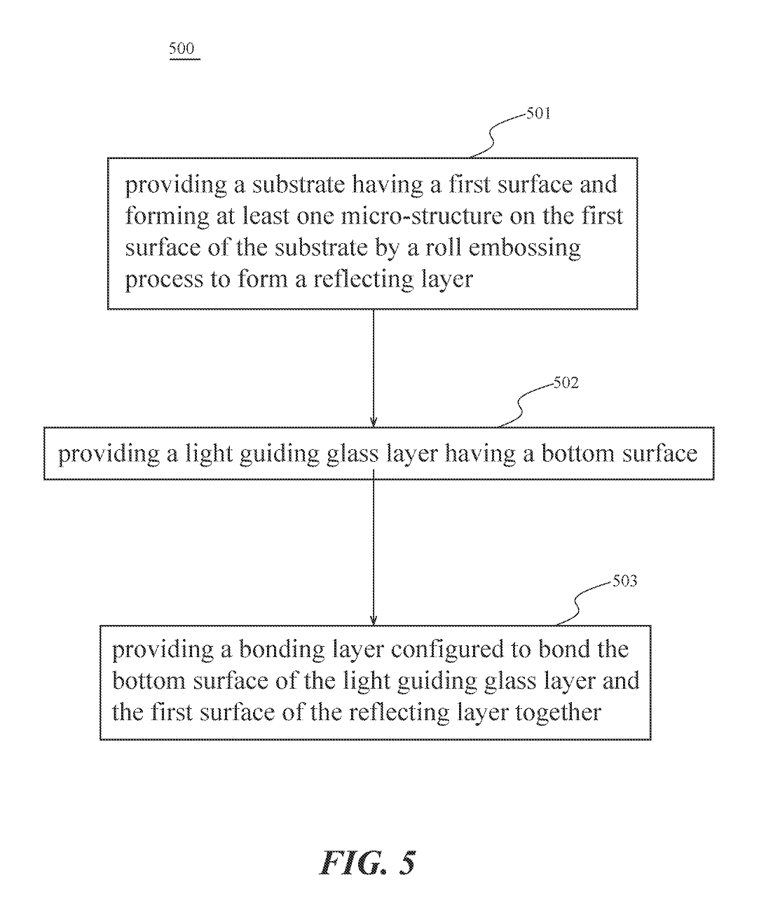

Please refer to FIG. 5 which shows the flow of the manufacturing method of a light guiding structure according to the present invention. The manufacturing method 500 includes the following steps: providing a substrate having a first surface and forming at least one micro-structure on the first surface of the substrate by a roll embossing process to form a reflecting layer (S501), providing a light guiding glass layer having a bottom surface (S502); and providing a bonding layer configured to bond the bottom surface of the light guiding glass layer and the first surface of the reflecting layer together (S503). The Steps in the manufacturing method 500 are described as follows.

The Step S501 in the manufacturing method 500 is to use a roll embossing process to form a substrate with a plurality of micro-structures. The shape and the distribution of the plurality of micro-structures on the first surface are determined by the mold of the roll embossing process, and the formed micro-structures must be capable of destroying the total reflection in the light guiding glass layer. If the substrate has the reflection feature itself, the first surface having the plurality of micro-structures is the reflecting surface. Furthermore, additional reflecting material can be formed on the first surface of the substrate via a vapor deposition step or other coating step to enhance the reflection effect. If the substrate with the plurality of micro-structures formed by the roll embossing process does not have the reflection characteristics, reflecting material must partially or totally cover the first surface of the substrate, so as to form a reflecting surface having the reflection characteristics.

The Step S502 in the manufacturing method 500 is to provide a light guiding glass layer without any micro-structure capable of destroying the total internal reflection therein. Therefore, it needs the plurality of micro-structures of the reflecting layer made by the Step S501 to destroy the total reflection of the light guiding glass layer to make the light entering into the light guiding glass layer and under the total reflection be emitted through the light-emitting surface of the light guiding glass layer, so that the light can be transmitted to the liquid crystal panel. In addition, the light guiding layer provided by the manufacturing method of a light guiding structure can be a light guiding acrylic layer or a light guiding layer made of other materials.

The Step S503 in the manufacturing method 500 is to provide a bonding layer, and preferably, the bonding layer is optical clear adhesive (OCA). The bonding layer not only bonds the bottom surface of the light guiding glass layer and the reflecting surface of the reflecting layer together, but also ensures that the light can be transmitted to the reflecting surface of the reflecting layer, so that the light can be transmitted via the micro-structures that destroy the total reflection to the liquid crystal penal from the light-emitting surface of the light guiding glass layer, so as to function as the light source of the liquid crystal display.

Using the light guiding structure, the display device with the light guiding structure and the manufacturing method of the present invention can increase the manufacturing speed and reduce the manufacturing cost. It is because the light guiding layer of the present invention, no matter whether it is a light guiding plate or a light guiding film, does not need to be processed by the screen printing technique or other special methods to form any micro-structure capable of destroying total reflection. Moreover, the process of screen printing spends more time and is difficult to be applied to the glass plate. It is impossible to process a huge glass plate by the screen printing technique and then to cut it into many pieces for the big size display panel, so that the huge glass plate must be cut first and then each of the glass pieces is separately/individually processed. However, using the roll embossing process to form the micro-structures in the reflecting layer can save more time and reduce the costs. Moreover, the material can be processed by the roll embossing method once (i.e. processed one time) and the processed material can be cut into pieces for the size and the amount on demand, rather than being cut first and then processed by the screen printing steps. In other words, the present invention simplified the manufacturing process of light guiding plates, and it does not need additional time to do the special process. Namely, the light guiding plate of the present invention does not have any micro-structure capable of destroying the total reflection. Instead, the micro-structures capable of destroying the total reflection are formed on the reflecting layer by roll embossing method.

The invention need not be limited to the disclosed embodiments and the wording/terms, and it is intended to cover various modifications and similar arrangements included within the spirit of the present invention and the scope of the appended claims.

What is claimed is:

1. A light guiding structure, comprising:
a light guiding layer including a first surface and a second surface; and
a reflecting layer including a reflecting material and a substrate having a first surface and a second surface, wherein the first surface of the substrate has at least one micro-structure, and the reflecting material at least partially covers the first surface of the substrate to form the reflecting layer,
wherein the first surface of the substrate is configured opposite the second surface of the light guiding layer.

2. The light guiding structure as claimed in claim 1, further comprising a bonding layer configured between the second surface of the light guiding layer and the first surface of the substrate, so as to bond the light guiding layer and the reflecting layer together, wherein the guiding layer is free from a structure capable of destroying total reflection.

3. The light guiding structure as claimed in claim 2, wherein the bonding layer includes an optical clear adhesive.

4. The light guiding structure as claimed in claim 2, wherein the bonding layer has a thickness, and the thickness ranges from 10 μm to 1000 μm.

5. The light guiding structure as claimed in claim 1, wherein the at least one micro-structure includes one of a pattern, a Lambertian surface, a V-cut structure and a microlens.

6. The light guiding structure as claimed in claim 1, wherein the reflecting layer has a thickness, and the thickness ranges from 1 μm to 1000 μm.

7. The light guiding structure as claimed in claim 1, wherein the light guiding layer is one of a light guiding glass layer and a light guiding acrylic layer.

8. The light guiding structure as claimed in claim 1, wherein the reflecting material is one selected from the group consisting of an aluminum (Al), a silver (Ag), a gold (Au), a copper (Cu) and a combination thereof.

9. The light guiding structure as claimed in claim 1, wherein the reflecting layer is formed at least by a roll embossing process.

10. A liquid crystal display, comprising:
a light guiding layer;
a reflecting layer including a substrate having at least one micro-structure; and
a bonding layer configured between the light guiding layer and the reflecting layer to bond the light guiding layer and the reflecting layer together.

11. The liquid crystal display as claimed in claim 1, wherein the reflecting layer further includes a reflecting material, and the reflecting material at least partially covers the substrate to form the reflecting layer.

12. A manufacturing method of a light guiding structure, comprising:
providing a substrate having a first surface and forming at least one micro-structure on the first surface of the substrate by a roll embossing process to form a reflecting layer;
providing a light guiding layer having a bottom surface; and
providing a bonding layer configured to bond the bottom surface of the light guiding layer and the first surface of the reflecting layer together.

13. The manufacturing method as claimed in claim 12, wherein the step of forming the reflecting layer further includes providing a reflecting material to at least partially cover the first surface of the substrate.
